(19) United States
(12) Patent Application Publication
(10) Pub. No.: US 2005/0216320 A1
(43) Pub. Date: Sep. 29, 2005

(54) Method of determining requirements for modification of a business operation

(76) Inventor: Brian Hattaway, Lenexa, KS (US)

Correspondence Address: DAVID E. HERRON II, PO BOX 2778, KANSAS CITY, KS, 66110, US

(21) Appl. No.: 10/755,509

(22) Filed: Jan. 12, 2004

(51) Int. Cl. G06F 17/60

(52) U.S. Cl. 705/7

(57) ABSTRACT

The invention is a method of determining requirements for modification of a business operational system. The method includes the step of compiling an inventory of current business capabilities, and also includes the step of enumerating at least one modified capability that differs from the current business capabilities. The method also includes the step of defining a set of requirements to be at least one difference detected during the step of performing the delta analysis.

### BACKGROUND OF THE INVENTION

The enhanced Telecommunications Operations Model prescribes set relationships of a company's infrastructure, product development, business strategies, and business operations within the context of providing customer service to those who use the business. The enhanced Telecommunications Operations Model (hereinafter eTOM) is the generally accepted business model for telecommunications companies.

The eTOM, as any model for business operation, must be adapted to suit the needs of a particular business. As such, the eTOM accommodates the need for adaptation and improvement upon current business practices that exist within specific applications of eTOM.

The current invention provides a system that is well-suited to fit within the framework of the eTOM by developing a systematic approach to improvement of the business capabilities of any business currently using eTOM as its foundation. However, even though the inventive method is well-suited to improve a business model that is founded upon eTOM, the principles and aspects of the invention may be used in any industry, including those businesses falling outside the telecommunications industry.

### SUMMARY OF THE INVENTION

The invention is a method of determining requirements for modification of a business operational system. The method is well-suited to improve current business operational systems, especially business operational systems requiring advanced information systems technology and components, and those systems using multi-networked computer systems. However, the fundamentals and teachings of this method may be used to determine requirements for modification of any business operation system in general, regardless of the size, number or complexity of the components, or the technological requirements of a given system. For example, the inventive method may be used by a business owner desiring to open a new store.

The inventive method will include the step of carefully creating an inventory of current business capabilities. This step may involve the tasks of assessing or itemizing the people who contribute to each respective business capability. A business capability, for the purpose of this patent application, is defined as a single actor (which may comprise a system, a person, or a group of people) performing a single logical unit of work that results in a defined and measurable goal that is completed in a single transaction or a single point in time. Thus, a capability is made up of several components that are necessary to specify the complete operation of a business. Generally, these components are: Business Processes, People, and Tools (systems).

Additional components within the capability are the metrics (the criteria used for measuring the effectiveness of the business capability); the Business Data (to describe the important data necessary to make process decisions, or data necessary to be passed to other capabilities); skills (to describe the knowledge that the People executing the capability must have); the M & P (the methods and procedures necessary for the People to interact with the Tools (systems) in a way that conforms to the Business Process.

Thus, the definition of ‘capability’ is intended to be malleable and changeable, not only to fit the needs of diverse types of business, but also to fit the changes that may encounter a single business. The components of a business capability that are set forth herein are certainly not intended to be exhaustive, and different components may be added to the definition of a capability. If a capability is redefined by adding a component or two, then the remaining steps of this inventive method may have to be re-performed taking the new component(s) into consideration.

For example, if one desires to use the inventive method herein in conjunction with an advertising business, then advertising demographics and methods of obtaining information relevant to these demographics may be needed as required components of such a business capability.

The task of creating the inventory may also include the step of assessing the business processes involved with each respective business capability. Further, inventorying the current business capabilities may also require assessment of the tools required to carry out each respective business capability.

The method also includes the step of proposing a set of new or modified business capabilities. This step involves enumerating at least one business capability that differs from the current business capabilities—this will become the new (or modified, as the case may be) business capability. Generally, the set of new or modified capability(ies) propose correction of the areas of desired improvement of the current business capabilities.

Additionally, the method also includes performance of a delta analysis, which involves listing the current business capabilities (which includes all of the components that make up the respective business capability, namely the Process Steps, the Metrics, the Skills, Business Data, as set forth above) on the one hand, and juxtaposing this list with a set of modified business capabilities on the other. Once the delta analysis is completed, one must then determine what items in the list of modified capabilities differ from those listed in the current business capabilities. This step is called “defining the requirements.” These requirements can be specific to any of the elements of the business capability. For example, some of the requirements can be for training, others could be for revising the metrics that measure performance, others could be for revising the M&Ps that govern the manual portion of the process...as identified by the delta analysis.

In order to assist in assessing the people required to carry out the respective business capability, the inventive method suggests that one should examine and determine the metrics required to carry out each respective business capability. As used in this application, metrics are defined as the criteria or standards used to evaluate the performance of an actor performing the respective business capability. For the purpose of this application, an “actor” may be either a person or a system. Further, in order to assess the people involved, the inventive method also suggests that one should carefully examine the skills necessary to carry out each respective business capability. This assessing step may also include the step of determining the education, experience, and training level of the people who are required to carry out the respective business capabilities.

The inventive method may include the step of preliminarily surveying the current business capabilities, and documenting skills required to operate the current business capabilities. Additionally, one may also document points of pain related to the areas of desired improvement. The phrase “points of pain” means any area that tends to cause a disproportionate amount of difficulty or error when the current business operational system is used. Also, the inventive method may also include the important step of examining and documenting any preconditions or assumptions that have been made regarding information received in the compiling step. Further, the inventive method may also include the step of documenting important business processing scenarios for the respective business operational system.

In order to carry out the method, it is advisable to define respective roles for each of user, a process owner, and a system owner. The user is a representative of the business operational system who is most familiar with the current business capabilities. The process owner is a representative of the business operational system who knows the current business capabilities. Finally, the system owner is a representative of the business operational system most familiar with information systems pertaining to the business operational system. Of course, a single person may fill each of these respective roles, or may each may be a group of persons, such as a management division within a large company. Further, in smaller companies, a single person may fill one or more of the different respective roles.

Once the respective roles and responsibilities are defined, the inventive method suggests that each of the user, system owner and process owner should collectively perform the inventorying step. It is advisable that each of the persons contributes the inventory step, as it is unlikely that any one could successfully complete the inventory without the other. As a practical matter, the inventory step is preferably accomplished by having all required parties together to discuss each of the steps and interactions between the manual process and the system-driven process by the user. Consequently, one using the method is advised to have each respective role present in the same room at the same time, which helps complete the picture of how to completely describe the pertinent set of current business capabilities.

In some instances, however, a single person may fill multiple roles; this may occur when the capability under discussion is an obscure business flimction that only one person knows, and therefore this person may fill each of the roles with respect to that specific business fuiction or business capability. It also may occur if the company is small, and the respective structure of the respective business entity requires one person to fill more than one respective role, as it pertains to the business capability.

The inventive method suggests that one should compare the results obtained from each respective role (i.e., the user, system owner and process owner) that were obtained during the inventorying step, as enumerated above.

The inventive method may also include the step of gathering, by the user, of existing reports and metrics pertaining to the current business capabilities. Additionally, the invention may also require the process owner to gather existing process documentation pertaining to the current business capabilities. The process owner should also assemble the methods and procedures incorporated into the set of current business capabilities.

With regard to the preliminary survey, the inventive method may also include an analysis and documentation of any pre-conditions and assumptions that were made regarding information received.

The step of defining the requirements may be multi-faceted. Indeed, it may include the steps of: (a) determining a set of inputs required for the modified business capability; and, (b) defining key considerations for carrying out the modified business capability; and (c) formulating a set of desired outputs for the modified business capability.

This unique method is an exciting addition and improvement upon the state of the art of improving business capabilities. Other objects, advantages and novel features of the present invention will become apparent from the following detailed description of the invention when considered in conjunction with the accompanying drawings.

### BRIEF DESCRIPTION OF THE DRAWINGS

FIG. 1 is a chart showing the framework for the enhanced Telecommunications Operations Model, which is admitted prior art.

FIG. 2 is a chart detailing, in as few textual words as possible, the general structure of a business capability and its design components, according to the principles of the current invention.

FIG. 3 is a chart detailing, in as few textual words as possible, the methods for investigating a system's business capabilities.

FIG. 4 is a chart detailing, in as few textual words as possible, the method of determining requirements for modification of a business operational system, according to the principles of the invention.

### DETAILED DESCRIPTION OF THE PREFERRED EMBODIMENTS

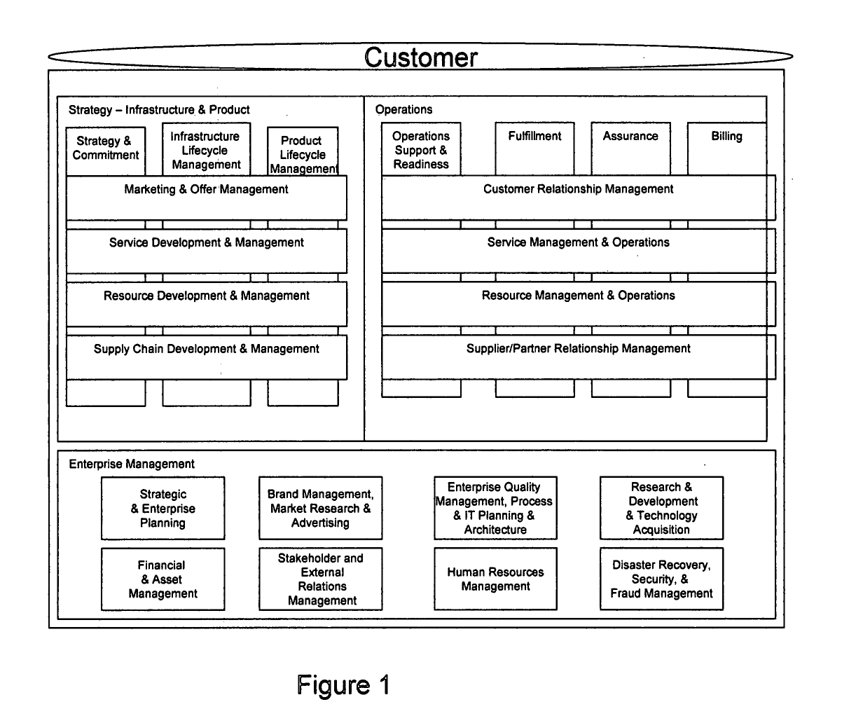

FIG. 1 shows a chart detailing the interrelationships of various aspects of a telecommunications business. FIG. 1 is a diagram showing the generally accepted enhanced Telecommunications Operations Model. As shown, the concerns and the demands of the customer often shape the formulation of the business strategy, the infrastructure and product development of the business. Also, the concerns and demands of the customer also can affect the general operations of the business.

As shown in FIG. 1, which is admitted Prior Art, the eTOM has set forth a series of aspects for the operation of one's business under the model. The four main areas of concern, as depicted, are in the Customer Relationship Management, the Service Management & Operations, the Resource Management and Operations, and the Supplier/Partner Relationship Management. Each of these four main aspects are considered in developing strategies Operations Support and Readiness, Fulfillment of customer demands, assurance of customer satisfaction, and of course, billing of customers.

Within the eTOM Framework, it is quite common to frequently assess the current needs of the business to ascertain whether any areas within the Operation of the business could use improvement. The invention provides a systematic approach for improvement of the current business capabilities of a business entity.

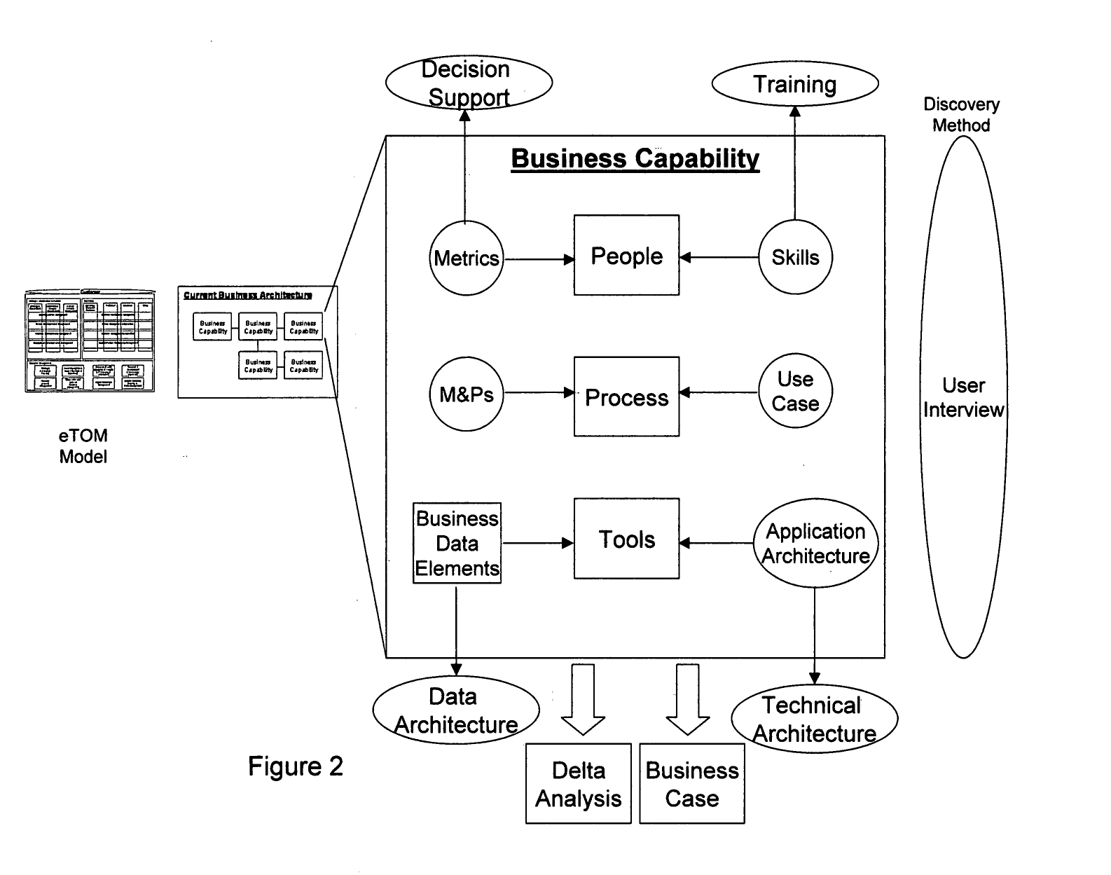

FIG. 2 is a chart detailing the components of a business capability. A business capability is defmed as a single actor (which may comprise a system, a person, or agroup of people) performing a single logical unit of work that results in a defmed and measurable goal that is completed in a single trsaction or a single point in time. As depicted in FIG. 2, a capability is made up of several components that are necessary to specify the complete operation of a business. Generally, these components are: Business Processes, People, and Tools (systems).

Additional components within the capability are the metrics (the criteria used for measuring the effectiveness of the business capability); the Business Data (to describe the important data necessary to make process decisions, or data necessary to be passed to other capabilities); Skills (to describe the knowledge that the People executing the capability must have); the M & P (the methods and procedures necessary for the People to interact with the Tools (systems) in a way that conforms to the Business Process.

Still referring to FIG. 2, therefore, an analysis of a business design capability requires one to carefully examine the people pertaining to the capability. Specifically, an analysis of this aspect invites an inquiry into the skill level, the education and training level of the pertinent person or persons involved. Also, an analysis of the people will necessarily involve an inquiry into the applicable metrics used to evaluate the performance of the people involved in carrying out the business capability. As noted above, metrics are defined as the criteria or standards used to evaluate the performance of an actor performing the respective business capability.

As depicted in FIG. 2, a breakdown of each business capability will also require an inquiry into the process or processes used to carry out the business capability. Generally, the process requirement involves an analysis and enumeration of the methods and procedures pertaing to the respective process. In order to determine and enumerate the people, processes and tools pertaining to each business capability, one must generally compile a preliminary inventory of each business capability. In order to assist in compiling the inventory, one often resorts to a “use case” which is defined as a specific instance or example that pertains to a respective business capability.

Still referring to FIG. 2, a breakdown of each business capability will also require an inquiry into the tools used to carry out the business capability. An inquiry into this facet generally requires an inquiry into the data systems and applications architecture pertaining to each respective tool.

As shown in FIG. 2, there are often areas of consideration that influence the development or application of the respective business capability. For example, when one performs a delta analysis (discussed in greater detail hereinafter), the results of the delta analysis may expose a new set of skills will be required in order to carry out the new or modified capability. Consequently, the training programs of the business may need re-tooling to accommodate the skill gaps that may result from implementation of modifications to the current set of business capabilities.

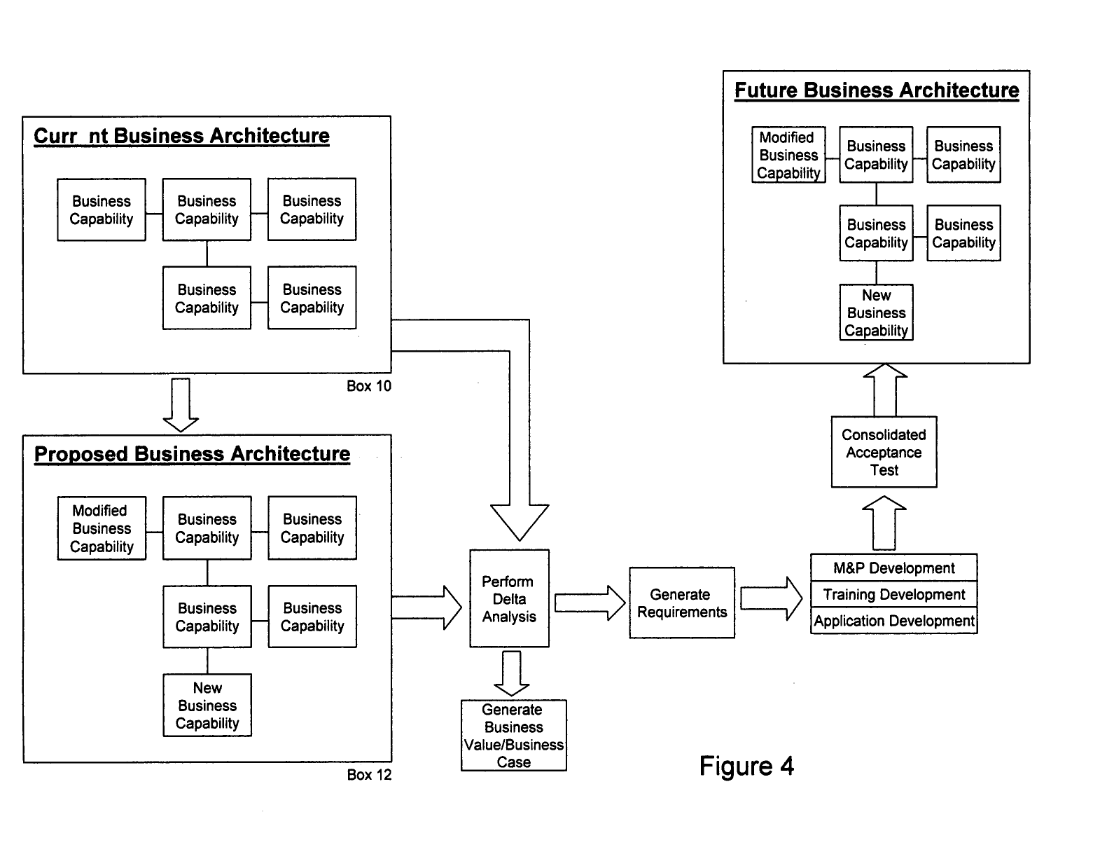

As enumerated in FIG. 2, a carefully performed delta analysis allows one to generate some value statements about the difference between the current state, and the proposed future state. As such, the delta analysis enables the creation of a business case (depicted in BOTH FIGS. 2 and 4).

In many ways, therefore, the delta analysis provides an integral element in the inventive method. Specifically, a careful enumeration of all the key components uncovers the detail of all areas that form part of a respective business capability (i.e., the skills, process, data, metrics, etc.). The delta analysis then performs the step of comparing the areas that give rise to new requirements.

Moreover, the required components of a ‘business capability’ will necessarily vary depending on the type of business operational system that will be modified using the inventive method. The components called out herein work well for systems development, however, when the inventive method is employed to assess other business entities (such as opening a new store), there may be additional aspects that would be included in a.capability definition

Further, the business may implement a new system of decision support, which could shape or develop the set of metrics that are used to evaluate the performance of the people involved with the business capability.

Referring specifically to FIG. 2, the data elements required within the business capability will impact the data architecture that pertains to the tools aspect of a respective business capability. Analogously, the tools required to carry out the business capability may impact the specific application architecture involved in carrying out the respective business capability. Data Architecture is defined as an organized collection of data elements aggregated from ALL the business capabilities.

Still referring to FIG. 2, and by way of illustration, let us assume that a business operation desires to adopt a new step of distributing data reports to at least one manager in each nine-digit zip code, then this new capability will require the data to conform—i.e., there must be a nine-digit zip code. In this example, the new data element (i.e., the Zip+4) must be added to the data architecture. Therefore, changes in the tools required in carrying out new or modified business capabilities will often cause one to change the data and application architecture present in the system.

Still referring to FIG. 2, a careful analysis of the three main aspects (namely, the people, process, and tools) of a respective business capability will also give insight into the business value or business case associated with the change in business capability.

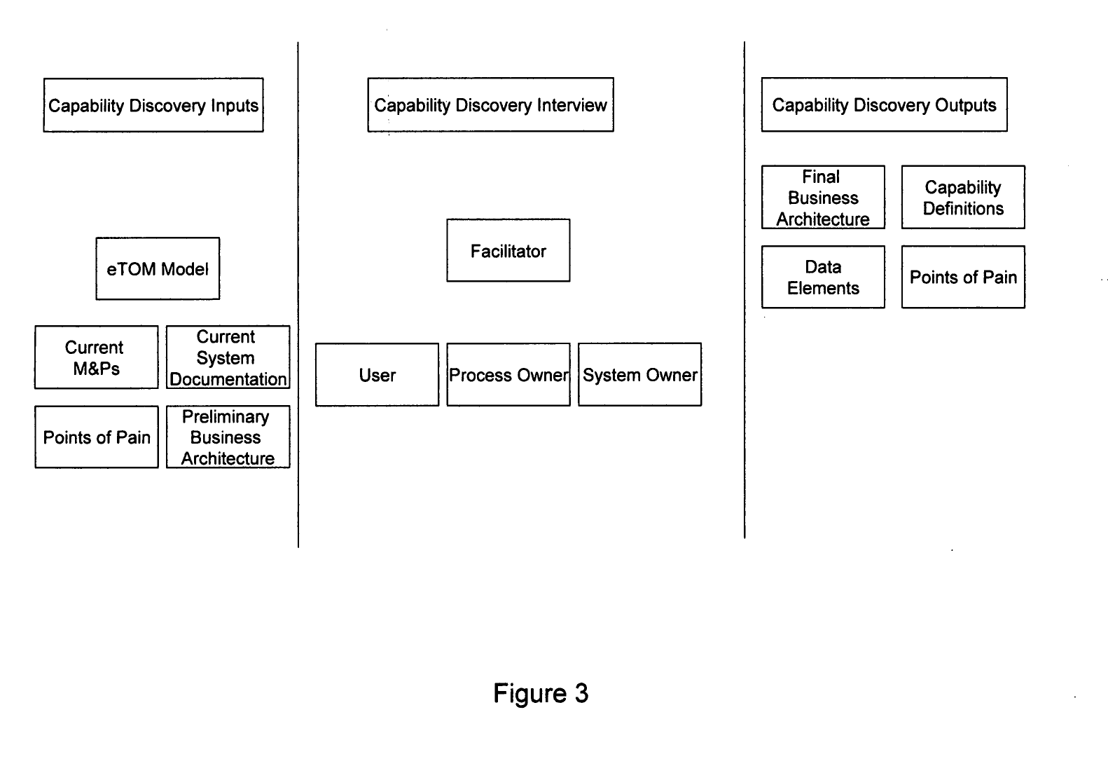

FIG. 3 is a chart detailing the ways one inventories the current business capabilities in order to provide a framework for the enhancement of the current business capabilities. Specifically, one must carefully examine the ‘inputs,’ which will include the current methods and procedures, and the current system model and report descriptions. The inputs will include known points of pain—i.e., known glitches or trouble points—of the current system.

As shown in FIG. 3, the inventory of the current capabilities of a business model involves a detailed discussion into the existing business flow that results from the implementation of the respective current capability. This discussion will include, but is not limited to, a discussion and documentation of the following: (a) identification of the existing process; (b) identification of the person(s) performing the process; (c) what skills are required of the person(s) performing the process; (d) identifying the metrics captured as a result of performing the process; (e) exposing the assumptions that have been made regarding connection to other processes, organizations or systems.

Still referring to FIG. 3, the inventorying of the components of the business capabilities further includes the aspect of developing desired outputs, which include the production of an as-is high level capability design, and deriving a precise definition of the respective capability. Generally, the precise definition will include a detail of the data elements involved in the process, and will also expose, discuss, and address known points of pain with regard to the current capability. Also, the desired outputs will also address the capability flow; alias, how this capability relates to other capabilities in carrying out the business model.

FIG. 4 is a diagram which details several ingredients of the inventive method, according to the principles of the invention. Once a careful and searching inventory has been performed, the existing capabilities that pertain to an existing process or procedure are assembled, as shown in Box 10. Generally in response to a need for improvement, one proposes a new set of business capabilities, as shown in box 12.

As shown in FIG. 4, Box 10 includes an assembly of respective business capabilities; some of which are related and/or lead to another business capability. The ingredients of Box 12 have a similar structure. Many of the capabilities are similar, and have similar interrelation; however, note that Box 12 contains a Modified Capability s well as a brand new capability, each of which differs from the existing group of business capabilities within Box 10. The specific interrelation of the respective business capabilities is referred to as the “business architecture.”

The business architecture is used as a tool for defining the overall operation of the business. As the business continues to expand its processes, then the collection of capabilities will likewise grow. For example, if the first project deals with billing, the process outlined will only enumerate capabilities associated with billing. Analogously, if the next project relates to ordering, the business architecture will grow as the new capabilities defined for ordering are enumerated. Thus, the business architecture—the collection of interrelated business capabilities—will help document the operating model for the business.

The business architecture can be used as a planning tool to help management plot the evolution of their business (by planning to create new capabilities, augment existing capabilities, automate manual portions of capabilities, or combining/consolidating redundant capabilities).

Still referring to FIG. 4, the inventive method requires one to perform a delta analysis, which includes the steps of juxtaposing the current capabilities, as in Box 10, with a proposed set of new capabilities, as in Box 12. In order to perform the Delta Analysis, one must break down each respective business capability into its component parts: its people, processes, and tools, as discussed in detail with regard to FIG. 2.

The Delta Analysis step, referred to in FIG. 4, therefore involves the listing of the components of the current business capabilities, and juxtaposing this list with an enumeration of the components necessary to carry out the proposed business process, namely the capabilities within Box 12.

Once the lists are juxtaposed, one should compare the elements of each list. Those elements or components that pertain to capabilities in Box 12 that are NOT included in the current set of business capabilities are thus defined as “Deltas” as highlighted by the Delta Analysis step.

Once the Deltas are defined, as referred to in FIG. 4, one must enumerate what must be done in order to address the gap identified by each specific delta. Specifically, one should examine whether current methods and procedures need to be further developed in order to accommodate the change in business capabilities. Further, one should inquire as to whether additional training programs should be implemented in order to better equip the people involved. Further, one should enumerate any further application development—namely, changes to currently-used software programs or tools—would be required in order to meet the gaps identified in the delta analysis. These enumerations to close the gaps identified by the delta analysis are known as requirements.

As shown in FIG. 4, once the requirements are addressed and new aspects of M&P development, Application Development, and Training Development are put into place, the system is given a Consolidated Acceptance Test to analyze whether the newly developed capabilities actually achieves the desired result. Generally, this involves a “probationary period” wherein the system owner, process owner, and user implement the improvements for a period of time, then gather information regarding metrics or performance data with the overall goal of determining whether the modifications improve the system. If the proposed changes pass the Consolidated Acceptance Test, then the changes are implemented on a more permanent basis. At this point, therefore, the “to be process” becomes the “current process”—and then, the entire process for improvement of the current process may repeat itself in accord with further proposed improvements of the model.

In addition to the aforesaid, the inventive method includes a second embodiment that may be used to determine the business feasibility of a proposed modification. Generally, however, this use of the inventive method is done before changes are implemented, and is often used to develop requirements that are sufficient to perform feasibility analysis.

Before it is determined that a project should be deployed, a higher level of “feasibility requirements” are generated. These “feasibility requirements” are used to generate a high level estimate of both the cost of the project and the benefit of the project. Consequently, this second embodiment inherently performs a cost-benefit analysis to determine whether the project to change the current system should proceed. If the project proceeds—then the business incorporates the method steps of the first embodiment, as discussed herein.

This second embodiment of the method is a much abbreviated as compared to the first embodiment of the method. In this second embodiment, the capability definition is expanded to a higher level, usually a broad business area such as order entry, billing, etc. The second embodiment involves capturing the process “use cases” and little else. Indeed, skills, metrics, data and the like are not considered in this second embodiment. The business case is then made by doing a delta analysis between “capability areas” on the process steps only. Note that the major reason for doing this work is to derive the business case, as referred to above, and depicted in FIGS. 2 and 4.

Another embodiment of the inventive method may also be used to define high level requirements for use in feasibility assessment. This embodiment of the method involves describing a Capability Area, and enumerating the high level process steps (use cases) associated with that capability area for the “AS-IS” process. Then the appropriate people (user, process owner, system owner) will develop the high level process steps (use cases) associated with the capability area for the “TO-BE” process. The delta analysis will be performed on this set of information (between as-is and to-be process areas). In this embodiment, high level requirements and business value statements will be defined and generated as a result of the delta analysis, just like it is done in other embodiments of the method.

### The Method Applied: A Specific Example

As with any business model, general method steps are perhaps best illustrated by showing how the method would work in a specific environment. As noted before, the inventive method is well-suited to improve upon the current practices of a business using the eTOM model, but the invention is nonetheless applicable to other models as well. To illustrate, the invention will be discussed in terms of a proposed way of improving the way examiners draft Office Actions, and in particular PTO Form 892 (the Notice of References Cited) that must accompany each Action.

Suppose that, in a recent meeting of primary examiners, SPEs, Group Directors, and Patent Office Information Technology Specialists, a primary examiner pointed out a particular “point of pain” with respect to her current job. Specifically, she pointed out that the completion of the PTO Form 892 was often arduous and time consuming, and in the haste to make production, the primary frequently encountered PTO-892s having typos, misspellings, or traibed numbers that involved human error. The primary inquired as to whether the current system could be improved to reduce human error and thereby make the process of completing the PTO-892 more efficient.

Applying the Business Capability components, as defined in FIG. 2, an initial step would be to define the capability. In the current instance, the business capability would be defined as the act of the patent examiner performing the task of completing a Form PTO-892, a required enclosure for an initial Office Action.

Referring to FIG. 2, the people involved in carrying out the respective capability are the PTO examining corp. This group of people is generally well-trained with specific knowledge of patent office procedures, the basics of drafting office actions using Actionwriter, and the fundamentals of patent law. Also, each examiner has an education background of at least a bachelor's degree in the pertinent art, and is often quite familiar with basic computer programming and/or word processing or keyboarding skills. With regard to metrics, the Patent Office has established performance criteria that (depending on the respective Art Unit) a certain number of Counts must be completed each bi-week. Further, each Count is generally accompanied by a PTO-892 form.

With specific regard to the “process” aspect as shown in FIG. 2, an examiner completing a PTO-892 has the benefit of a fillable form on his or her computer. This fillable PTO-892 has several areas that require the examiner to enter respective data. For example, the fillable PTO-892 has a column for entry of a respective patent number, another column for entry of the effective date, another column for the inventor name, and yet another for the classification of the respective reference.

With specific regard to the “tools” aspect as shown in FIG. 2, the examiner completing thePTO-892 uses a derivative of Word or Wordperfect containing the fillable form. This fillable form is generally obtained from a mainframe or server that is networked to each of the respective examiners' personal computers. As the form is completed, the application architecture allows the respective PTO-892 to be saved to the examiner's computer, and the examiner adds the PTO-892 to the Office Action.

With further regard to FIG. 2, the use case analysis would yield the following steps, as it would apply to a proposed modified business capability:

a. PTO Examiner inputs patent numbers of cited references for a given pending application

b. PTO Examiner presses the <retrieve reference>button (new button) on the PTO Form 892 that is next to the citation entry line

c. System retrieves Patent Name, Patent Owner, and Patent Date for the Patent Number that was input

d. System checks that Patent Date of retrieved patent is prior to the Application Date of the current patent

e. System displays Patent Name, Patent Owner, and Patent Date next to the patent number that was input on the citation entry line.

Generally, the above discussion has tacitly and implicitly applied the processes set diagramed in FIG. 3, as it regards this specific example. With regard to the roles and responsibilities that pertain to the applicable business capability of completing the PTO-892, the Process Owner is the United States Patent & Trademark Office, or perhaps the person delegated by the Office of the Commissioner who is responsible for overseeing the productive examination of patent applications. With regard to this specific example, namely, the process owner is responsible for overseeing the business process as a whole, and has detailed knowledge of the existing business capabilities. In this example, the system owner is the technical staff of programmers and IT specialists who devise and draft tools that assist examiners. And of course, the Users, in this model, comprise the patent examining corps of the United States Patent & Trademark Office.

As diagramed in FIG. 3, an inventory of the current business capabilities show that many examiners consider the arduous task of completing the PTO-892 a minefield for error. For example, one could easily transpose two numbers of the 7-digit patent number, or, one could misspell or misstate the patentee name or effective date of the reference. Worse yet, one may even inadvertently cite a reference within a PTO-892 that fails to qualify as prior art—if indeed the respective reference cited was filed after the pending application. Thus, these are points of pain that should be addressed in proposing a new set of capabilities. As shown in FIG. 3, a Business Requirements Development Team would then explore the ways of improving the current system.

It is proposed that an examiner merely input the patent number into the fillable PTO-892, and then the applicable remaining information would automatically be inserted into the remaining respective columns for each respective row. Indeed, the PTO server includes a database of each and every U.S. Patent. Thus, the proposed system seeks a way of integrating the information input into this column by the examiner with this database of the PTO server.

Applying the methodology set forth in FIG. 4 to the current example, a delta analysis will need to be performed to determine the different requirements between the existing system and the proposed improved system. Specifically, the Delta Analysis would yield the following:

Step a: Examiner inputs the pending application serial number, and the patent numbers of cited references into a fillable PTO-892 Form (same as existing system, so no new requirements result here)

Step b:. PTO Examiner presses the <retrieve reference>button (new button) on the PTO Form 892 that is next to the citation entry line Requirement 1: System must provide the ability to accept a patent number Requirement 2: System must provide a <retrieve reference>button to initiate the patent number lookup function. Requirement 3: Procedures must be updated to inform users that they no longer have to manually input the remaining citation information Requirement 4: Patent officer productivity metrics should be adjusted to recognize the time savings associated with the automation of this lookup Requirement 5: Training documentation should be updated to reflect input of patent number only (not the entire citation)

Step c: System retrieves Patent Name, Patent Owner, and Patent Date for the Patent Number that was input Requirement 6: System must provide the ability to retrieve a patent number in the appropriate system

Step d. System checks that Patent Date of retrieved patent is prior to the Application Date of the current patent Requirement 7: System must provide a new field in the data model to the patent examiner—Patent Date (which has never been retrieved before) Requirement 8: System must display an error message if the date of the cited patent is after the date of the current patent.

Step e System displays Patent Name, Patent Owner, and Patent Date next to the patent number that was input on the citation entry line.

Thus, a delta analysis, as set forth in the chart in FIG. 4, would yield at least eight requirements that differ from the current practice. Also, the Delta Analysis would also show that the current business capability does not include a way to correct common errors—such as transposed digits in a patent number, misidentified inventors, or the erroneous citation of a reference that does not qualify as prior art.

Furthermore, these new requirements may require reevaluation and re-tooling in order to accommodate the changes. For example, if this new system saves a significant amount of time for each examiner, the management may desire to increase production requirements (i.e., the metrics) in order to more accurately define and determine an examiner's work productivity. Of course, these requirements will also mandate data architecture modification; specifically, one must make the database of United States Patents accessible, which may also spring the requirement for additional software (i.e., tools) that could accommodate this task.

Thus as it regards our specific example, a Requirement has been defined, as set forth in the chart in FIG. 4. The requirement, basically stated, is system that accesses and integrates information from the Patent database with this respective column of: a PTO-892.

Also, the inventive method, as applied, requires one to examine any assumptions that have been made. In the instant case, we have assumed that examiners have only cited United States Patents in the PTO-892. Data regarding examiner-cited non-patent literature will not be applicable to this business capability, and this improvement—if implemented—will have no effect on the aspect of completing the PTO-892 with respect to non-patent literature, such as treatises, newspaper articles or the like.

Still applying the specific example to the diagram set forth in FIG. 4, now that these Requirements have been defined, the current fillable form software must be amended so that the word processing program used to complete the PTO-892 can access data from the patent database, and then input the accessed data into the proper place on the form after the examiner hits an “enter” key. This will certainly require some significant application development in the form of changes in the word-processing software used to draft the PTO-892. It may also require a short training session to familiarize examiners with the new system. The new capability may also require that new methods and procedures regarding the PTO-892 be taught to the entire examining corps.

As shown in FIG. 4, once the new requirements are put into place and new capabilities are put into place the Commissioner may conduct a Consolidated Acceptance Test to determine whether examiners' production has increased by virtue of the new system. This generally involves examining and comparing data for the six-month period following implementation of the change to the six-month period prior. Also, the Consolidated Acceptance Test may involve performing a cost-benefit analysis. Specifically, this requires an in-depth balancing of the time and money spent investing in improvements to the system on the one hand versus the improvement of examiner production on the other

The Consolidated Acceptance Test involves the testing of all of the components of the capability, and the testing of the inter-relations between the components of the capability. Thus, when the capability is deployed, there is no disruption to current business.

An example of a Consolidated Acceptance Test would be as follows: first, confirm that M&Ps have been developed, training lessons have been updated, and the new PTO-892 software has been completed. Now the test is ready to begin.

A number of “green” patent examiners (who have previously not been involved in requirement definition) will be excused from their normal duties for a brief period of time to perform the Consolidated Acceptance Test. The new examiners will receive the training, they will receive a copy of the new M&P documents, and they will receive an acceptance test script that calls out specific scenarios for using the new PTO-892 software. For example, one step would be to retrieve patent number 1234567, and the expected result would be the retrieval of the corresponding patentee name, patentee information, and date (as set forth in the requirements). Another step would be to retrieve patent number which has a patent date after the current date. The expected result will be that an error message will be displayed for the examiner stating that the citation is not relevant prior art.

If the new patent examiners are unsuccessful in using the new button—then either their training was flawed or their M&Ps were not specific enough, and the training scripts or M&Ps must be revised. If the application allows the second patent citation to be added successfully to the record (without displaying the prior art exception message)—then there is a defect in the PTO-892 software, and this must be corrected. Once the Consolidated Test Coordinator (usually the project manager) is satisfied that all components of the business capability are functioning correctly, the new “Cite Reference” capability can be rolled out to the entire Patent Office Examiner staff.

Hopefully, this specific example has assisted in fostering a better understanding of the inventive method. Of course, the method herein claimed and disclosed has broad application, and need not be limited to the telecommunications industry, the eTOM, or the improvement of the completion of PTO Form 892.

Although the present invention has been described and illustrated in detail, and a specific example has been given, these are for illustration and example only, and are not to be taken by way of limitation. The spirit and scope of the present invention are to be limited only by the terms of the appended claims.

1. A method of determining requirements for modification of a business operational system, the method comprising the steps of:
compiling an inventory of current business capabilities;
enumerating at least one modified capability that differs from the current business capabilities; wherein,
the at least one modified capability proposes correction of the areas of desired improvement of the current business capabilities;
performing a delta analysis by juxtaposing the inventory of current business capabilities with the at least one modified business capability;
defining a set of requirements to include at least one difference detected during the step of performing the delta analysis.

2. The method as in claim 1, wherein the compiling step includes the steps of:
assessing people contributing to each respective business capability;
assessing processes involved with each respective business capability; and,
assessing tools involved required to carry out each respective business capability.

3. The method as in claim 2, wherein the step of assessing the people contributing to each respective business capability further includes the steps of:
determining metrics used to evaluate performance of each person in carrying out each respective business capability;
assessing the skills necessary to carry out each respective business capability.

4. The method as in claim 3, wherein the step of assessing the skills further comprises the step of determining the education and training of the people required to carry out each respective business capability.

5. The method as in claim 1, further including the steps of
conducting a preliminary survey of the current business capabilities;
documenting skills required to operate the current business capabilities;
documenting points of pain related to areas of business capability that do not function properly;
documenting pre-conditions and assumptions about information received in the compiling step;
documenting important business processing scenarios.

6. The method as in claim 5, wherein the compiling step further includes the steps of:
documenting any pre-conditions and assumptions regarding information received as a result of the preliminary capability survey.

7. The method as in claim 1, further including the steps of:
selecting at least one user, namely a representative of the business operational system who is most familiar with the current business capabilities; and,
selecting at least one process owner, who is a representative of the business operational system who knows the current business capabilities; and,
selecting at least one system owner, who is a representative of the business operational system most familiar with information systems pertaining to the business operational system; and,
comparing results of the compiling step of each of the at least one user, the at least one process owner, and the at least one system owner.

8. The method as in claim 7, further including the steps of:
gathering, by the user, of existing reports and metrics pertaining to the current business capabilities.

9. The method as in claim 7, further including the steps of
gathering, by the process owner, of
existing process documentation pertaining to the current business capabilities; and,
methods and procedures of the current business capabilities.

10. The method as in claim 1, wherein the step of defining the set of requirements includes the steps of:
determining a set of inputs required for the modified business capability;
defining key considerations for carrying out the modified business capability;
and formulating a set of desired outputs for the modified business capability.

11. The method as in claim 1, further including the steps of defining a respective set of roles and expectations from each of
at least one process owner who possesses knowledge of the current business process and function, and who will be the overall responsible party for defining the modified business capability; and,
at least one system owner, each being a representative from an informational systems group involved with the business operational system, each system owner being most familiar with the requirements of the modified business capability, and who will represent business processes that are inbedded in the system and who will assist the process owner in defining the modified business capability;
at least one system user, each being a representative of a group that is most familiar with the business logic required for the modified business capability, and who is expected to represent the business needs from a field perspective.

12. The method as in claim 1, further comprising the step of
enumerating at least one differing capability that differs from the current business capabilities, said at least one differing capability being at least one of a new capability or a modified capability;
and, adding the differing capability to the current business capabilities; wherein,
the delta analysis further includes the step of juxtaposing the inventory of current business capabilities with the at least one differing capability.

13. The method as in claim 1, further comprising the steps of
deriving a business value statement as to the at least one difference that is uncovered during the delta analysis.

14. The method as in claim 1, further comprising the steps of
determining an interrelationship between each of the current business capabilities and the at least one modified business capability, thereby defining a business architecture; and,
estimating a business value associated with the business architecture.

15. The method as in claim 14, further comprising the steps of
deriving at least one of new business capabilities or modified business capabilities resulting from changes to the business architecture.

16. A method of determining requirements for modification of a business operational system by proposing modified business capabilities that improve upon current business capabilities, the method comprising the steps of:
assessing people contributing to each respective current business capability;
assessing processes involved with each respective current business capability;
assessing tools involved required to carry out each respective current business capability;
conducting a preliminary survey of the current business capabilities;
documenting skills required to operate the current business capabilities;
documenting points of pain of the current business capabilities,
documenting pre-conditions and assumptions about information received in the compiling step;
documenting important business processing scenarios;
enumerating at least one modified capability that differs from the current business capabilities;
relating the points of pain to the at least one modified business capability;
selecting at least one desired new capability that is not included in the current capabilities of the current business capabilities; wherein,
the at least one modified capability and the at least one desired new capability propose correction of the areas of desired improvement of the current business capabilities;
performing a delta analysis by juxtaposing the list of current business capabilities with the set of modified business capabilities;
determining a set of inputs required for the modified business capability;
defining the key considerations for carrying out the modified business capability;
and formulating a set of desired outputs for the modified business capability; and,
defining a respective set of roles and expectations necessary to carry out the modified business capability, the respective roles and expectations being from each of
at least one process owner having process ownership of future systems, and who possesses knowledge of the current business process and fuiction, and who will be the overall responsible party for defining the modified business capability; and,
at least one system owner, each being a representative from an informational systems group involved with the business operational system, each system owner being most familiar with the requirements of the modified business capability, and who will represent business processes that are imbedded in the system and who will assist the process owner in defining the modified business capability;
at least one system user, each being a representative of a group that is most familiar with the business logic required for the modified business capability, and
who is expected to represent the business needs from a field perspective;
conducting a preliminary survey of each of the at least one user, the at least one process owner, and the at least one system owner to determine the feasibility of the modified business capability;
comparing respective results derived from the preliminary survey step, the results being obtained from of each of the at least one process owner, the at least one system owner, and the at least one system user.

17. A method of determining requirements for modification of a business operational system by proposing modified business capabilities that improve upon current business capabilities, the method comprising the steps of:defining a capability area for a the current business operational system;
enumerating at least one use case, each of which is associated with the capability area;
defining a list of current business capabilities associated with each use case;
defining at least one of
a modified business capability or a new business capability;
performing a delta analysis by juxtaposing the list of current business capabilities with the set of modified business capabilities;
defining a set of requirements to include at least one difference detected during the step of performing the delta analysis; and,
deriving a business value statement based upon the set of requirements.
